(19) United States
(12) Patent Application Publication
(10) Pub. No.: US 2007/0253630 A1
(43) Pub. Date: Nov. 1, 2007

(54) Method and apparatus for fast and flexible digital image compression using programmable sprite buffer

(75) Inventor: Oliver K. Ban, Austin, TX (US)

Correspondence Address: FREDERICK W. GIBB, III;Gibb & Rahman, LLC, 2568-A RIVA ROAD, SUITE 304, ANNAPOLIS, MD, 21401, US

(73) Assignee: International Business Machines Corporation, Armonk, NY (US)

(21) Appl. No.: 11/412,205

(22) Filed: Apr. 26, 2006

(51) Int. Cl. G06K 9/46

(52) U.S. Cl. 382/243

(57) ABSTRACT

A system and method of performing digital image compression comprises comparing pixels in various locations in a digital picture image frame; coding a position of pixels located in a foreground of the digital picture image frame; sending the coded positions of the pixels located in a foreground of the digital picture image frame to a frame buffer of a sprite controller; separating a background pixel group from a foreground pixel group in the digital picture image frame based on the coded positions; compressing the pixels in the foreground pixel group; and transmitting a frame number and a frame buffer parameter dimension corresponding to the compressed pixels to a digital picture image display viewer.

### CROSS REFERENCE TO RELATED APPLICATIONS

This application generally relates to co-pending U.S. patent applications entitled (1) “Method and Apparatus for a Fast Graphic Rendering Realization Methodology Using Programmable Sprite Control” (Docket No. YOR920050502US1) and (2) “Apparatus for Monitor, Storage and Back Editing, Retrieving of Digitally Stored Surveillance Images” (Docket No. YOR920050507US1) filed concurrently herewith, the contents of which in their entireties are herein incorporated by reference.

### BACKGROUND

1. Technical Field

The embodiments herein generally relate to image processing, and, more particularly, to digital image compression techniques used for image processing.

2. Description of the Related Art

The conventional digital image compressing systems 100 are normally transformation based systems, typically either Discrete Cosine Transform (DCT) based or fractal transformation based, as shown in FIG. 1. Generally, the intra-frame compression and inter-frame search algorithms are 8×8 DCT transformation based, for most of the commercial application and standards, while the rest are fractal transformation based. Typically, these transformation based systems 100 use the nature characteristics of similarity between neighboring pixels, thus by selective quantization, to reach the goal of information representation reduction.

Typically, in the inter-frame algorithm, all of the coding and transformations occur around the 8×8 boundaries. In the intra-frame algorithm, the motion search algorithms are also pixel based and not outside of the 8×8 box. The P-frame and B-frame search modes are also based on the average DCT based values in between frames, thus is still based on the 8×8 frame. However, the above parameters represent a limitation for image compression. Therefore, there remains a need for a digital image compression technique that is fast and flexible.

### SUMMARY

In view of the foregoing, the embodiments herein provide a method of performing digital image compression, and a program storage device readable by computer, tangibly embodying a program of instructions executable by the computer to perform the method, wherein the method comprises comparing pixels in various locations in a digital picture image frame; coding a position of pixels located in a foreground of the digital picture image frame; sending the coded positions of the pixels located in a foreground of the digital picture image frame to a frame buffer of a sprite controller; separating a background pixel group from a foreground pixel group in the digital picture image frame based on the coded positions; compressing the pixels in the foreground pixel group; and transmitting a frame number and a frame buffer parameter dimension corresponding to the compressed pixels to a digital picture image display viewer.

The method may further comprise comparing pixels outside of an 8×8 64 pixel box scope in the digital picture image frame. Moreover, the method may further comprise compressing the pixels in the foreground pixel group based only on the coded positions. Preferably, the transmission of the frame number and the frame buffer parameter dimension corresponding to the compressed pixels to the digital picture image display viewer occurs periodically and depends on characteristics of the digital picture image frame. The method may further comprise configuring the sprite controller as a mini Cathode Ray Tube Controller (CRTC). Preferably, the configuration of the sprite controller is variable. Furthermore, the method may further comprise using a comparator to separate the background pixel group from the foreground pixel group, wherein the comparator preferably comprises exclusive OR digital logic.

Another embodiment provides a system for performing digital image compression, wherein the system comprises a digital picture image frame comprising pixels; and a sprite controller comprising a dimension register array adapted to code a position of pixels located in a foreground of the digital picture image frame; a frame buffer adapted to store the coded positions of the pixels located in a foreground of the digital picture image frame; a comparator adapted to separate a background pixel group from a foreground pixel group in the digital picture image frame based on the coded positions; an image compressor adapted to compress the pixels in the foreground pixel group; and a picture image frame counter adapted to process a frame number and a frame buffer parameter dimension corresponding to the compressed pixels. Preferably, the pixels are outside of an 8×8 64 pixel box scope in the digital picture image frame. Furthermore, the image compressor is preferably adapted to compress the pixels in the foreground pixel group based only on the coded positions. Additionally, the system may further comprise a transmitter adapted to transmit the frame number and the frame buffer parameter dimension corresponding to the compressed pixels; and a digital picture image display viewer adapted to receive the transmission from the transmitter, wherein the transmission of the frame number and the frame buffer parameter dimension corresponding to the compressed pixels to the digital picture image display viewer occurs periodically and depends on characteristics of the digital picture image frame. Moreover, the sprite controller preferably comprises a mini CRTC. Also, the comparator preferably comprises exclusive OR digital logic. Preferably, the configuration of the sprite controller is variable.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a schematic diagram of a conventional computer or electronic system;

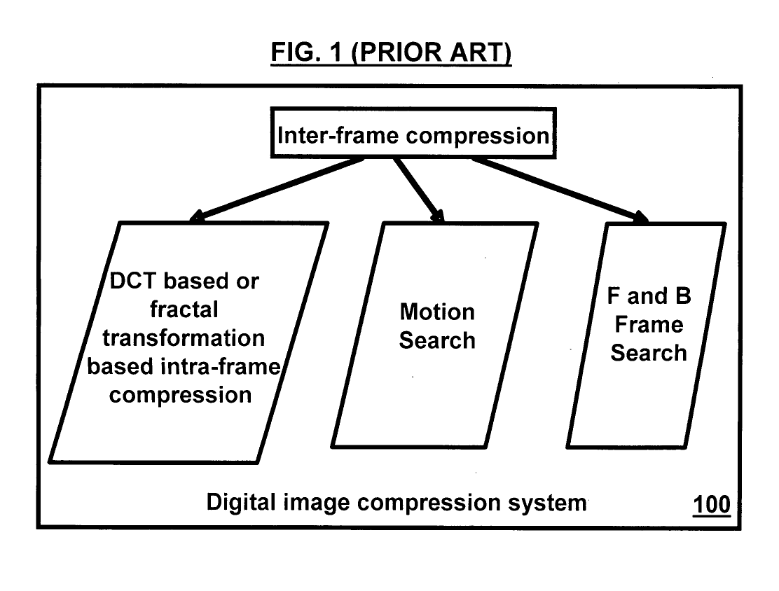

FIG. 2 illustrates a graphical representation of a picture frame;

FIG. 3 illustrates a schematic diagram of an image compression architecture according to an embodiment herein;

FIG. 4 illustrates a schematic diagram of an image controller architecture according to an embodiment herein;

FIG. 5 illustrates a computer system diagram according to an embodiment herein; and

FIG. 6 is a flow diagram illustrating a preferred method of an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

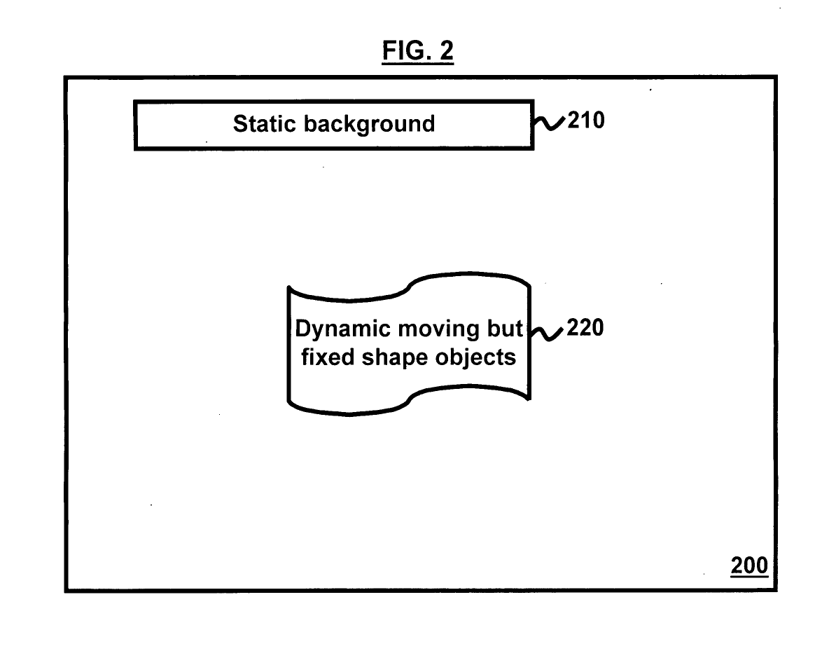

As mentioned, there remains a need for a digital image compression technique that is fast and flexible. The embodiments herein achieve this by providing a programmable sprite buffer used for digital image compression. Referring now to the drawings, and more particularly to FIGS. 2 through 6, where similar reference characters denote corresponding features consistently throughout the figures, there are shown preferred embodiments.

As illustrated in FIG. 2, most picture frames 200 have the following characteristics: (1) most of the pictures have a large portion of the “background” 210 that is relatively static, such as a flower bed; (2) there are always relatively small but relatively fixed shaped “foreground” objects 220 that move inside the picture frames 200; and (3) statistically, the entropy of the picture 200, from the inter-frame point of view, is not evenly distributed. In this context, “entropy from the inter-frame point of view” means that inter-frame (the pixels outside the single same frame) picture's entropy is unevenly distributed inside the entire frame 200; e.g., small portion of picture frame 200 changes between frames, but a large portion remains the same.

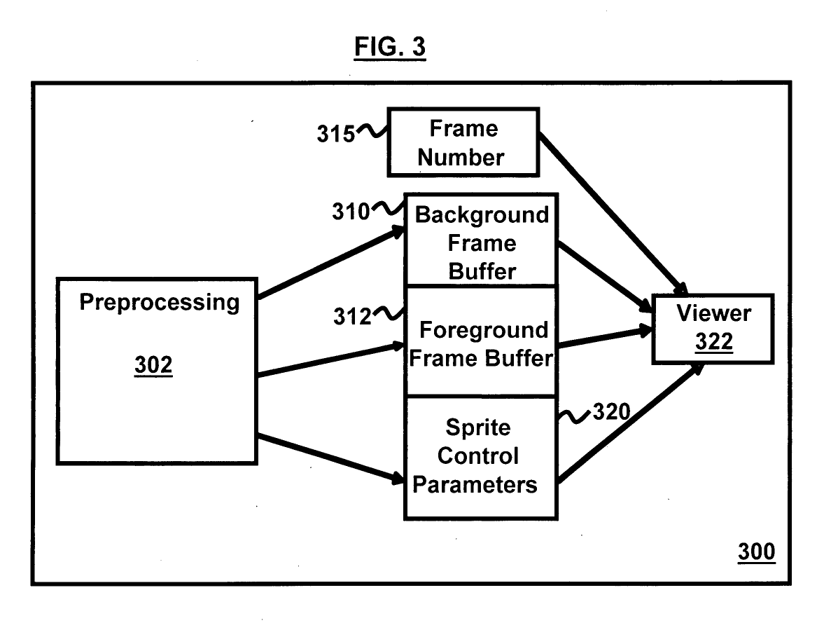

The embodiments herein provide a technique of separating the “background” pixel group 210 and the “foreground” pixel group 220, outside of the 8×8 64 pixel box scopes. An 8×8 64 pixel box scope is simply an 8×8 pixel square box; e.g., 64 pixels. By comparing the frames in between the pixel level; i.e., comparing within box or block level; e.g., group of pixel levels, not a single pixel level, the foreground 220 can be separated out and put into a frame buffer 312 of a sprite controller 300 as shown in FIG. 3 by saving the portion of the moving pixel into the frame buffer 312 in the sprite controller 300; thus only the frame number 315 and dimensions of the sprite controller's parameter 320 are required to be transmitted instead of the pixel values. These features help to separate the foreground pixels 220 by only providing the information that is actually needed to reconstruct the original image. This is advantageous (i.e., not transmitting pixel values) because it saves channel capacity, wherein the channel capacity refers to the transmission of packets or bits. Thus, the image compression is realized in a very high compression ratio rate of compression, wherein the ratio rate depends on the characteristic of the pictures. The compression ratio rate equals the post-compression total number of bits divided by the pre-compression total number of bits.

The compressing is accomplished from only the coded parameters that are needed to be transmitted; the pixels in the foreground and background frame buffer 312, 310, respectively, only have to be transmitted periodically, depending on the nature of the pictures; i.e., the entropy of the pictures such as the uniformity of the picture. In other words, only the coded information is transmitted, not the original picture frame 200. Preferably, buffers 310, 312 are configured as one piece of hardware. The preprocessing 302 in FIG. 3 performs color rendering, cortex formation, pixel grouping and also image digitization and color space conversion tasks.

One aspect of the embodiments herein is the architecture of the sprite controller 300 that separates the foreground pixels 220 and the background pixels 210, thus drastically reducing the amount of information that has to be transmitted. According to the embodiments herein, a “sprite” is a combination of small buffers 310, 312 and a logic (sprite) controller 320 that controls these buffers 310, 312, to move and separate pixels.

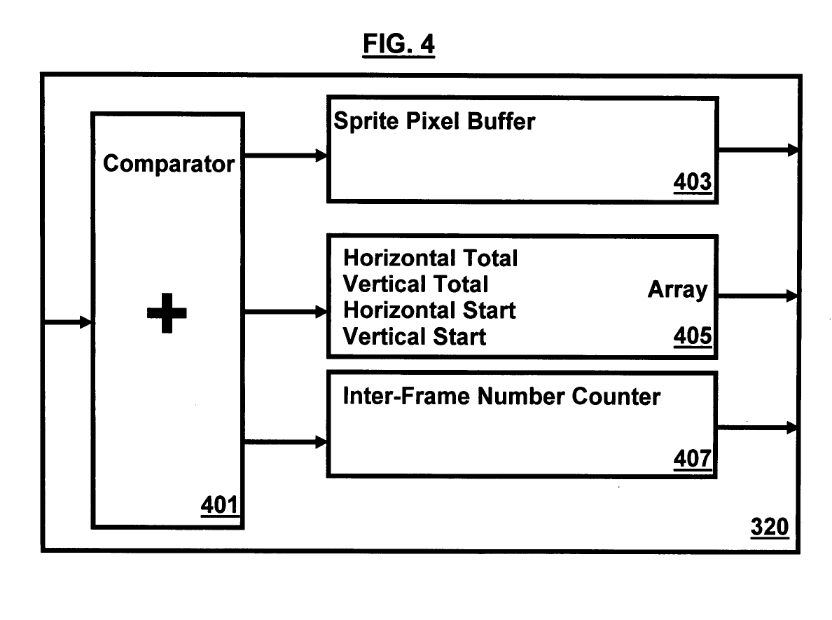

The implementation of the sprite controller 320 can be accomplished as illustrated in FIG. 4, wherein FIG. 4 is the detailed illustration of sprite controller 320 in FIG. 3. Preferably, the sprite controller 320 should have a small to medium sized frame buffer 403 to store the foreground pixel values 220. The size is flexible depending on the design constraints and picture processing speed considerations. Furthermore, the sprite controller 320 should preferably have a dimension register array 405 to code the position of the foreground pixels 220. The dimension register array 405 preferably comprises a two-tiered register of arrays that store the horizontal and vertical display parameters of the sprite controller 405. Moreover, the sprite controller 400 should preferably have a comparator array (motion analyzer) 401 (for example, exclusive OR logic) to distinguish the foreground sprite area 220 from the background 210.

In a preferred embodiment, the sprite controller 320 is implemented as a mini CRTC, with a small frame buffer 403. The CRTC is adapted to control the scan of pixels across the display on the CRT, including horizontal and vertical positions of the pixels and the value of the pixels. The shape of the sprite can be of any shape, such as in the case of FIG. 4, it is implemented in a rectangular shape, or it could be a circle or any other shape, even a variable shape so long as the shape position parameters can be easily coded. The “shape” of the motion analyzer 401 is the size of the motion analyzer 401, which may be flexible depending on the design constraints. In operation, the pixels come from the motion analyzer 401 and are stored in the sprite pixel buffer 403. The parameters from the motion analyzer 401 are stored and controlled in array 405 and inter-frame number counter 407.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can take the form of an entirely hardware embodiment, an entirely software embodiment or an embodiment including both hardware and software elements. Preferably, the embodiments are implemented in software, which includes but is not limited to firmware, resident software, microcode, etc.

Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

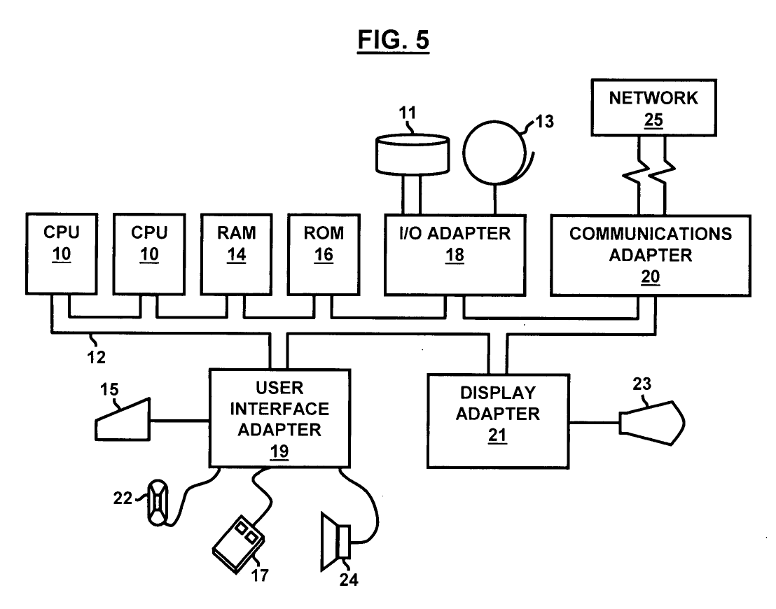

A representative hardware environment for practicing the embodiments herein is depicted in FIG. 5. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a RAM 14, ROM 16, and an I/O adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

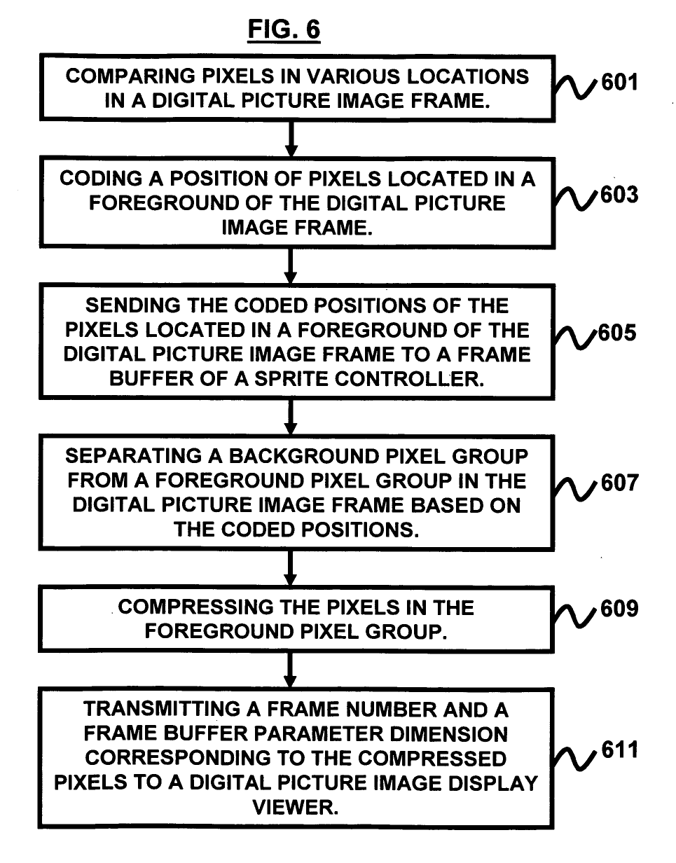

FIG. 6, with reference to FIGS. 2 through 5, is a flow diagram illustrating a method of performing digital image compression according to an embodiment herein, wherein the method comprises comparing (601) pixels in various locations in a digital picture image frame 200; coding (603) a position of pixels located in a foreground 220 of the digital picture image frame 200; sending (605) the coded positions of the pixels located in a foreground 220 of the digital picture image frame 200 to a frame buffer 315 of a sprite controller 300; separating (607) a background pixel group 210 from a foreground pixel group 220 in the digital picture image frame 200 based on the coded positions; compressing (609) the pixels in the foreground pixel group 220; and transmitting (611) a frame number 315 and a frame buffer parameter dimension 320 corresponding to the compressed pixels to a digital picture image display viewer 322.

The method may further comprise comparing pixels outside of an 8×8 64 pixel box scope in the digital picture image frame 200. Moreover, the method may further comprise compressing the pixels in the foreground pixel group 220 based only on the coded positions. Preferably, the transmission of the frame number 315 and the frame buffer parameter dimension 320 corresponding to the compressed pixels to the digital picture image display viewer 322 occurs periodically and depends on characteristics of the digital picture image frame 200. The method may further comprise configuring the sprite controller 300 as a mini CRTC. Preferably, the configuration of the sprite controller 300 is variable. Furthermore, the method may further comprise using a comparator 401 to separate the background pixel group 210 from the foreground pixel group 220, wherein the comparator 401 preferably comprises exclusive OR digital logic.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A method of performing digital image compression, said method comprising:
comparing pixels in various locations in a digital picture image frame;
coding a position of pixels located in a foreground of said digital picture image frame;
sending the coded positions of said pixels located in a foreground of said digital picture image frame to a frame buffer of a sprite controller;
separating a background pixel group from a foreground pixel group in said digital picture image frame based on the coded positions;
compressing said pixels in said foreground pixel group; and
transmitting a frame number and a frame buffer parameter dimension corresponding to the compressed pixels to a digital picture image display viewer.

2. The method of claim 1, further comprising comparing pixels outside of an 8×8 64 pixel box scope in said digital picture image frame.

3. The method of claim 1, further comprising compressing said pixels in said foreground pixel group based only on said coded positions.

4. The method of claim 1, wherein the transmission of said frame number and said frame buffer parameter dimension corresponding to the compressed pixels to said digital picture image display viewer occurs periodically and depends on characteristics of said digital picture image frame.

5. The method of claim 1, further comprising configuring said sprite controller as a mini Cathode Ray Tube Controller (CRTC).

6. The method of claim 1, wherein a configuration of said sprite controller is variable.

7. The method of claim 1, further comprising using a comparator to separate said background pixel group from said foreground pixel group, wherein said comparator comprises exclusive OR digital logic.

8. A program storage device readable by computer, tangibly embodying a program of instructions executable by said computer to perform a method of performing digital image compression, said method comprising:
comparing pixels in various locations in a digital picture image frame;
coding a position of pixels located in a foreground of said digital picture image frame;
sending the coded positions of said pixels located in a foreground of said digital picture image frame to a frame buffer of a sprite controller;
separating a background pixel group from a foreground pixel group in said digital picture image frame based on the coded positions;
compressing said pixels in said foreground pixel group; and
transmitting a frame number and a frame buffer parameter dimension corresponding to the compressed pixels to a digital picture image display viewer.

9. The program storage device of claim 8, wherein said method further comprises comparing pixels outside of an 8×8 64 pixel box scope in said digital picture image frame.

10. The program storage device of claim 8, wherein said method further comprises compressing said pixels in said foreground pixel group based only on said coded positions.

11. The program storage device of claim 8, wherein in said method, the transmission of said frame number and said frame buffer parameter dimension corresponding to the compressed pixels to said digital picture image display viewer occurs periodically and depends on characteristics of said digital picture image frame.

12. The program storage device of claim 8, wherein said method further comprises configuring said sprite controller as a mini Cathode Ray Tube Controller (CRTC).

13. The program storage device of claim 8, wherein a configuration of said sprite controller is variable.

14. A system for performing digital image compression, said system comprising:
a digital picture image frame comprising pixels; and
a sprite controller comprising:
a dimension register array adapted to code a position of pixels located in a foreground of said digital picture image frame;
a frame buffer adapted to store the coded positions of said pixels located in a foreground of said digital picture image frame;
a comparator adapted to separate a background pixel group from a foreground pixel group in said digital picture image frame based on the coded positions;
an image compressor adapted to compress said pixels in said foreground pixel group; and
a picture image frame counter adapted to process a frame number and a frame buffer parameter dimension corresponding to the compressed pixels.

15. The system of claim 14, wherein said pixels are outside of an 8×8 64 pixel box scope in said digital picture image frame.

16. The system of claim 14, wherein said image compressor is adapted to compress said pixels in said foreground pixel group based only on said coded positions.

17. The system of claim 14, further comprising:
a transmitter adapted to transmit said frame number and said frame buffer parameter dimension corresponding to the compressed pixels; and
a digital picture image display viewer adapted to receive the transmission from said transmitter,
wherein the transmission of said frame number and said frame buffer parameter dimension corresponding to the compressed pixels to said digital picture image display viewer occurs periodically and depends on characteristics of said digital picture image frame.

18. The system of claim 14, wherein said sprite controller comprises a mini Cathode Ray Tube Controller (CRTC).

19. The system of claim 14, wherein said comparator comprises exclusive OR digital logic.

20. The system of claim 14, wherein a configuration of said sprite controller is variable.
